(19) United States
(12) Patent Application Publication
(10) Pub. No.: US 2006/0139176 A1
(43) Pub. Date: Jun. 29, 2006

(54) Security tag assembly

(76) Inventors: Johan Skjellerup, Boca Raton, FL (US); Eddie L. Stenild, Kastrup (DK)

Correspondence Address: MALLOY & MALLOY, P.A.;Historic Coral Way, 2800 S.W. Third Avenue, Miami, FL, 33129, US

(21) Appl. No.: 11/008,641

(22) Filed: Dec. 9, 2004

(51) Int. Cl. A44B 9/00; G08B 13/14

(52) U.S. Cl. 340/572.9; 24/351

(57) ABSTRACT

A security tag assembly structured to prevent the unauthorized removal of merchandise from a given area such as a retail establishment comprising a base and an attachment member. A connector pin is secured to a seat portion of the base and extends outwardly there from into engagement with a locking assembly on an interior of the attachment member. The locking assembly restricts movement of the connector pin outwardly from the attachment member and is structured to be destructively detached from the pin when the base and the attachment member are forcibly separated thereby requiring the attachment member to be disposed of and replaced. The base is re-useable and includes a display field for exposing predetermined merchandise data or other information on an exterior of said base. An RF communication/signaling structure may be combined with the base for tracking and/or alarm activation purposes.

### BACKGROUND OF THE INVENTION

1. Field of the Invention

This invention relates to an anti-theft security tag assembly including a re-useable base and a disposable attachment member collectively but removably secured to various types of merchandise when in an operative position. The base includes a connector member mounted thereon and structured to interconnect the attachment member thereto as well as an external display field which facilitates viewing of predetermined information including merchandise data. An indicator assembly, which may include RF communication/signaling, capabilities is secured to the base is structured to activate an alarm

2. Description of the Related Art

Security or anti-theft tags are extensively used in the retail merchandising industry as well as numerous other areas of commerce. In typical fashion, such devices are attached to various types of merchandise in such a manner that that they are clearly obvious by one examining the merchandise. Common knowledge of the use and operation of such devices is believed to prevent or at least restrict the theft or other unauthorized removal of merchandise from the retail outlet or other area being monitored. More specifically, it is believed that such security tag devices serve as a deterrent to unauthorized removal in that a potential thief will recognize that the merchandise will be “stained” or otherwise marked, thereby rendering the merchandise useless, upon forced removal of the security tag. Alternatively the tag may be structured to activate an alarm system as the merchandise, incorporating the tag thereon, passes through a monitoring station typically located at the exits to the retail establishment.

Due to the popularity of security or anti-theft devices of the type described above, numerous attempts have been made to design and structure a device which not only serves as a deterrent against theft, but which includes structural features intended to overcome any attempt to defeat the device which may be applied by an experienced thief. In addition, the structure of such security devices should be such as to be easily secured to and removed from different types of articles such that a device of substantially standard structure can be used to monitor and protect various types of merchandise.

As set forth above known security or anti-theft tags are intended to provide some indication which either renders the merchandise useless or alternatively signals an attempted unauthorized removal. As such, at least one type of indicator is structured to release an ink or colored staining agent upon a forced removal of the security device from the merchandise, such as by rupturing the outer casing or other portions thereof. The released staining agent is difficult, if not impossible, to remove from the protected merchandise thereby clearly indicating that the stained article has been stolen. In addition, such anti-theft devices may include some type of electronic signaling mechanism. This type of device activates an alarm by passing through or in predetermined proximity to a monitoring station, as set forth above. However, because of the large number of practical applications for such security devices, users thereof may request one or more indicator assemblies that have a variety of performance characteristics including, but not limited to, staining, electronic signaling, etc. Also, a retailer may in fact desire more than one type of indicator or different types of “customized” indicator or signaling devices which better protect against the unauthorized removal of merchandise from a given area.

While popular, it is recognized that a significant number of the anti-theft tags currently being utilized include problems or disadvantages which render them less than totally efficient. More specifically, wide spread knowledge of the structural features of such security tags allows unauthorized personnel to develop techniques which are specifically designed to remove the tag from the merchandise in a manner which defeats the aforementioned indicator structures. Therefore it is not uncommon for a skilled or experienced thief to develop tools or techniques to remove the merchandise from the area being monitored without damage to the stolen article or activation of an alarm or monitoring system.

Accordingly there is a recognized need in the security industry for an anti-theft device preferably in the form of a relatively small security tag assembly which efficiently locks onto various types of merchandise and which is specifically structured to overcome known techniques to remove or otherwise defeat such devices. Moreover, such protective structural features should be compatible with an efficient tag construction and configuration. Therefore, allowing a security tag manufacture or provider to effectively “customize” the indicator assembly to include various “theft indicating” devices, electronic signaling devices or a combination thereof, while not requiring a restructuring or redesign of the entire tag or the remaining, basic operable components associated therewith.

### SUMMARY OF THE INVENTION

The present invention is directed to a security tag assembly structured to be connected to different types of merchandise in an operative position. When so connected, the structural and operative components of the security tag assembly prevents or at least restricts the unauthorized removal of the attached merchandise from a given area. The security tag assembly of the present invention is perhaps most commonly, but not exclusively, used and/or identified with retail sales outlets, wherein attempted theft of various merchandise products, commonly termed “shoplifting”, is commonplace. In order to prevent such illegal activity, the security tag assembly of the present invention is attachable to the protected merchandise in an efficient manner without causing damage thereto. In addition, the various structural and operative features of the preferred embodiments of the present invention allow the authorized detachment of the security tag assembly from the merchandise in a quick and easy manner and preferably, but not exclusively at the manufacturing site. However, removal of the security tag assembly by unauthorized personnel, such as when the merchandise is being displayed, can not be easily accomplished.

More specifically, the various preferred embodiments of the security tag assembly of the present invention include at least one base and at least one attachment member connectable together in the aforementioned operative position. However, as practically applied a plurality of bases and attachment members are utilized, such as when protecting and/or monitoring a plurality of products and merchandise as is commonly the practice in many retail outlets. As explained in greater detail hereinafter, at least one preferred embodiment of the present invention comprises each of the plurality of attachment members structured to be disposable after use and upon being removed from a corresponding base and the merchandise being protected. A different, unused attachment member then replaces the removed attachment member. In contrast, the one or more bases associated with the security tag assembly of the present invention are structured to include various structural and operative features which enable its reuse, such as including an indicator assembly and being independently connectable to any one of the plurality of attachment members, in an operative position.

The aforementioned operative position may be more specifically defined as the placement of a connector member, fixedly secured to the base and extending outwardly therefrom into interconnecting relation with one of the plurality of attachment members. As such, the connector member preferably includes an elongated pin secured to and extending outwardly from the base. Further, the connector pin may include a sharpened or pointed outermost end to facilitate penetration and/or connection to the merchandise being protected as well as passage into the interior of the corresponding attachment member. Further, when in the operative position the merchandise, depending upon its physical characteristics, will normally be clamped between exterior surfaces of the attachment member and the base. Such clamping engagement of the merchandise is also facilitated by the existence of a seat, for a connected attachment member, disposed on the exterior of the base. The seat preferably has a concave or other preferred configuration which corresponds to the convex or other preferred configuration of the exterior surface of the attachment member.

In order to maintain a secure connection between the base and the attachment member in the operative position and in clamping engagement with the merchandise being protected, each of the plurality of attachment members includes a locking assembly. The locking assembly is disposed on or within the attachment member in receiving relation to the connector member when the attachment member is being disposed in the operative position relative to its interconnection with the base. Further, the locking assembly is structured to permit passage of the connector pin into the attachment member but restrict movement of the connector pin in the opposite position, out of the attachment member. More specifically, the locking assembly of each of the plurality of attachment members is structured to movably engage the connector pin in a manner which permits travel thereof into the interior of the attachment member so as to assume the operative position. However, the structure and disposition of the locking assembly is such as to restrict movement of the connector pin in the opposite direction thereby preventing or restricting separation of the attachment member from the base.

The disposable nature of each of the attachment members is further emphasized by structuring the locking assembly so as to be deformed or destroyed, at least in terms of its originally intended operation, upon a forced removal of the connector pin from its interior interconnection with an attachment assembly. Therefore, the locking assembly of the plurality of attachment members can be described as being “destructively detached” out of movement restricting engagement with the connector pin upon a forced movement or travel of the connector pin out of the attachment member, such as when the attachment member and base are forcibly separated.

Yet another preferred embodiment of the present invention includes the structural feature of a display field located on the base such as, but not limited to, being positioned on an exterior, exposed surface thereof. The display field is disposed and structured to provide ready access to various informative data including merchandise information or the like as well as pricing and/or descriptive information regarding the product or merchandise being protected. Such predetermined data can vary and include, but not be limited to, bar codes or other types of optically scannable indicia, pricing information, color, size, material description and a variety of other information relating to place of origin, manufacture or distribution history of the product or merchandise. Therefore, as set forth above, an embodiment of the base incorporating the display field can be reused for an extended period by attaching it to products or merchandise corresponding to the informative data appearing within the display field. Further, the display field can be defined by printed information and/or removable or fixed labeling disposed in an exposed location for external viewing, scanning, optical reading, etc.

Also, the display field, with the pertinent information appearing thereon, can serve as a time and cost saving feature such as when the security tag assembly is attached to the merchandise at the manufacturing site of the merchandise. By way of example, many clothing products and like merchandise are manufactured in locales where labor costs may be significantly lower than in the geographical location where the merchandise is sold. Accordingly, attachment of the security tag, which has pertinent merchandise data appearing thereon, at the manufacturing site rather than at the retail outlet could result in significant savings in labor costs.

The repetitive and/or continued reuse of the base is further evidenced by the inclusion of an indicator assembly thereon. The indicator assembly may include one or more indicator members at least some of which have the ability to activate an alarm when passing through a security field such as typically found in association with the exits or entrances of various retail establishments. In addition, at least one embodiment of the indicator assembly of the present invention may comprise the indicator member having radio frequency (RF) communication/signaling capabilities. Accordingly, the base is structured to activate a security alarm such as, but not limited to, a proximity alarm of the type typically used to prevent the unauthorized removal of protected merchandise from retail or other facilities, as generally set forth above. Moreover, it is also possible that the RF tag can be adapted to “track” the merchandise to which it is attached, for purposes of inventory, security, logistics, etc.

Therefore, the various preferred embodiments of the security tag assembly of the present invention overcomes many of the problems and disadvantages associated with conventional or previously known security devices and embodies simple and efficient structure, which facilitates the attachment, removal and efficient practice of security as related to the unauthorized removal of the protected merchandise from a given area.

These and other objects, features and advantages of the present invention will become clear when the drawings as well as the detailed description are taken into consideration.

### BRIEF DESCRIPTION OF THE DRAWINGS

For a more complete understanding of the nature of the present invention, reference should be had to the following detailed description taken in connection with the accompanying drawings in which:

FIG. 1 is a perspective view of one preferred embodiment of the security tag assembly of the present invention.

FIG. 2 is a top view of the embodiment of FIG. 1.

FIG. 3 is a left side view of the embodiment of FIG. 2.

FIG. 4 is a bottom view of the embodiment of FIG. 2.

FIG. 5 is a right side view of the embodiment of FIG. 2.

FIG. 6 is a top view of the embodiment of FIG. 2.

FIG. 7 is a rear view of the embodiment of FIG. 2.

FIG. 8 is a perspective view in exploded form showing a separation of the various operative components of the embodiments of FIGS. 1 through 7.

FIG. 9A is an exploded view in partial cutaway and section showing the relative positions of the various operative components for the embodiments of FIGS. 1 through 8 in an unassembled orientation.

FIG. 9B is a sectional view in partial cutaway of the embodiment of FIG. 9A in an assembled orientation.

FIG. 9C is a sectional view in partial cutaway representing the separation of the operative components of the preferred embodiment of the present invention from that shown in FIG. 9B.

FIG. 9D is an exploded view in cross section and partial cutaway further representing the authorized operation of separating the various components from the position shown in the embodiment of FIG. 9B.

FIG. 10 is a perspective view in exploded form representing a detachment assembly for separating the operative components of the preferred embodiment of the present invention in accord with FIGS. 9C and 9D.

FIG. 11 is a perspective view of yet another preferred embodiment of the present invention incorporating an indicator assembly.

FIG. 12 is a front view and an exploded detail view showing structural details of the embodiment of FIG. 11.

FIG. 13 is a perspective view of yet another preferred embodiment of the present invention shown representing an operative and structural modification from the embodiment of FIGS. 11 and 12.

FIG. 14 is a front view and exploded detail view showing structural and operative details of the embodiment of FIG. 13.

Like reference numerals refer to like parts throughout the several views of the drawings.

### DETAILED DESCRIPTION OF THE PREFERRED EMBODIMENT

As shown in the accompanying drawings, the present invention is directed towards a security tag assembly generally indicated as 10 and comprising at least one base 12 and at least one attachment member 14. However, a practical application of the present invention would typically involve a plurality of bases 12 and a plurality of attachment members 14, such as when a plurality of different products were being protected and/or monitored. Moreover, the security tag assembly 10 is of the type structured to be removably secured to various types of merchandise 18 so as to prevent unauthorized removal of the merchandise 18 from a given area or location. Typical applications for the security tag assembly 10 of the present invention include the interconnecting of one base 12 and any one of a plurality of attachment members 14 to merchandise 18 being protected. As such, removal of the security tag assembly 10 from its operative position can be quickly and easily accomplished by authorized personnel utilizing approved techniques and/or hardware. To the contrary, separation of the base 12 and the attachment member 14 from the operative position and the protected merchandise extremely difficult when attempted by unauthorized personnel.

Further, at least one preferred embodiment of the present invention comprises each of the plurality of attachment members 14 being structured to be disposable after use, subsequent to being removed from a corresponding base 12 and the merchandise being protected. In contrast, the one or more bases 12 of the security tag assembly 10 of the present invention include various structural and operative features which enable their repeated use. Such features include, but are not limited to, an indicator assembly and a connector member which allows any one of the bases 12 to be connected to any one of the “unused” attachment members 14, as will be described in greater detail hereinafter.

More specific structural details of the various preferred embodiments of the present invention include the base 12 having a generally elongated or other appropriate configuration. In addition, maintenance of the merchandise 10 in a clamped orientation between the base 12 and the attachment member 14 is further facilitated by a seat 20 disposed on the base. The seat 20 is preferably configured so as to correspond to the outer surface configuration 14′ of the attachment member which is disposed in a substantially seated or aligned received relation within the seat 20. The structures of the preferred embodiments represented in the various figures include the seat 20 include a substantially concave configuration which substantially corresponds to the substantially convex configuration 14′ of the attachment member 14. Accordingly, when the base 12 and attachment member 14 are in the aforementioned and preferred operative position, the merchandise 18, depending upon its physical characteristics may be effectively clamped “within” the seat 20 between the base 12 and the outer surface portion 14′ of the attachment member 14.

In order to maintain a secure interconnection between the base 12 and the one or more attachment members 14, the base 12 is provided with a connector member generally indicated as 22 comprising an elongated connector pin or like structure 24. The innermost end 26 of the pin is secured to the base 12 preferably, but not necessarily, in cooperation with the seat 20. Moreover, the length of the connector pin 24 is sufficient to extend outwardly from the seat 20 as well as a remainder of the adjacent exterior surface 12′ of the base 12 so as to engage and be properly connected to the attachment member 14.

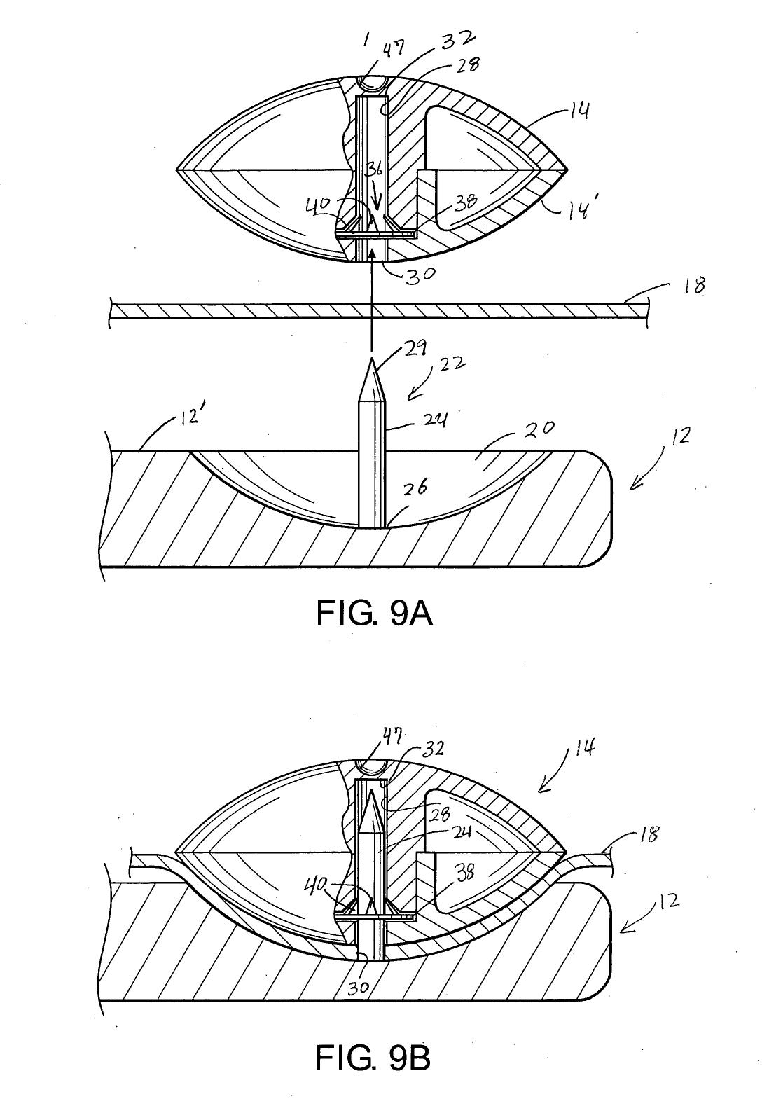

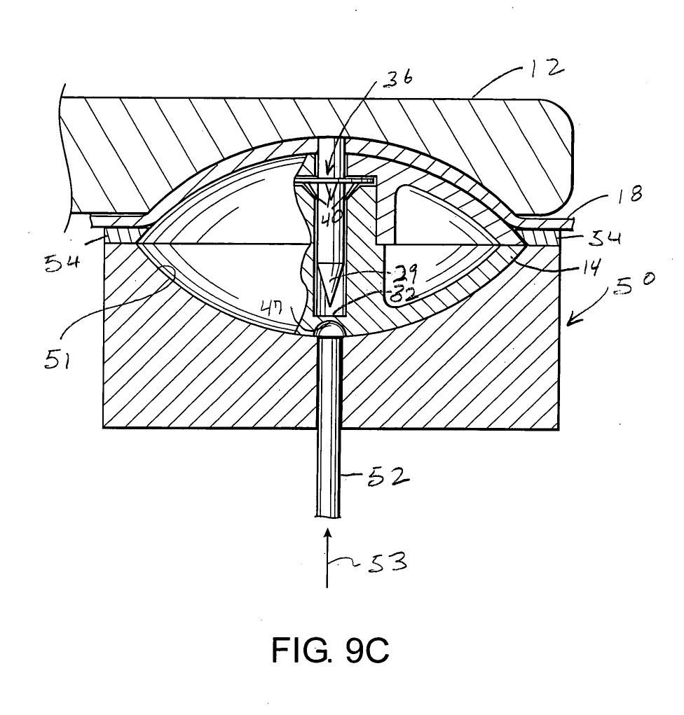

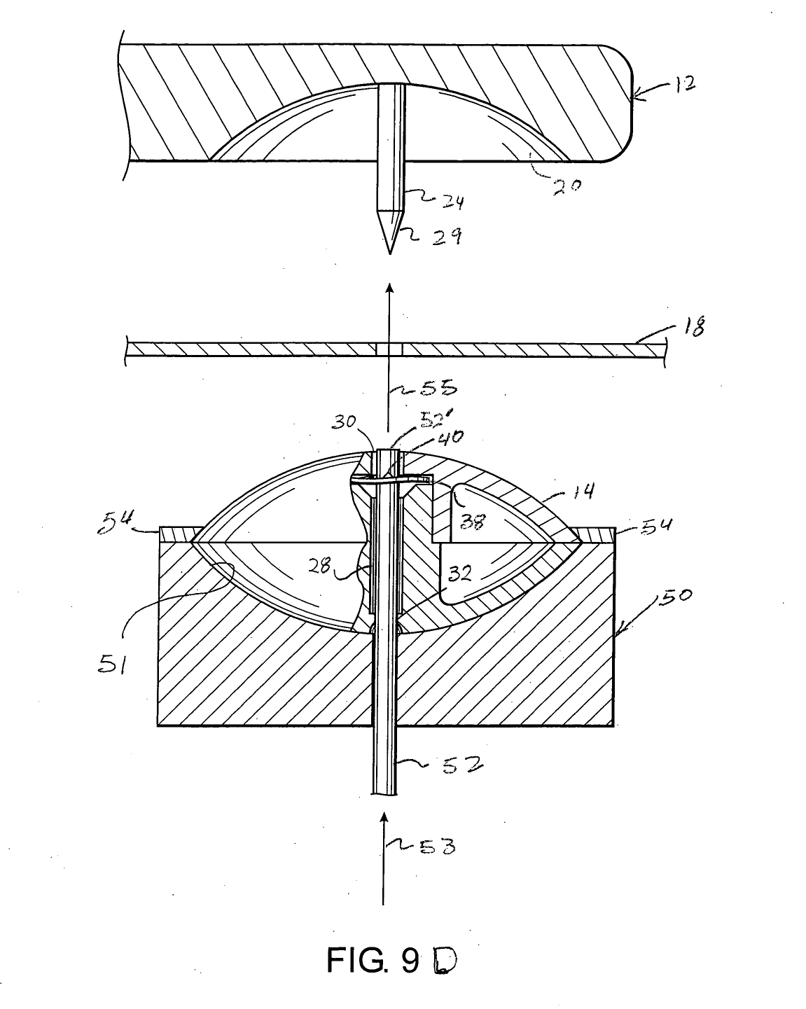

Cooperative structuring of each of the plurality of attachment members 14 includes an elongated passage or channel 28 disposed on the interior of the one or more attachment members 14. Moreover, the channel 28 has a proximal end 30, which is preferably open, as well as a distal end 32. Each of the proximal and distal ends, 30 and 32 respectively, are disposed contiguous with or immediately adjacent to opposed exterior surface portions of the one or more attachment members 14 as clearly demonstrated in FIGS. 9A through 9C. Therefore, the channel 28 extends substantially entirely along a transverse dimension of the attachment member which is at least partially defined by the location of the oppositely disposed proximal and distal ends 30 and 32, respectively. The securing of the attachment member 14 in the preferred, operative position comprises penetration of the merchandise 18 by the connector pin 24 and continued travel of the connector pin 24 through the open proximal end 30 and into the interior of the channel 28 and along a substantial portion of the length thereof. Penetration of the merchandise 18 by the connector pin 24 as well as its passage into the channel 28 may further be facilitated by a pointed or other appropriately shaped tip 29, as demonstrated.

Additional structural features of the various preferred embodiments of the present invention include the provision of a locking assembly generally indicated as 36. The locking assembly 36 is disposed on or preferably within the interior of the attachment member 14 and/or at least in communication with the channel 28 and open end 30 so as to be disposed in receiving relation to the connector pin 24. Therefore, as the connector pin 24 is disposed within the channel 28, it will pass through the open proximal end 30 and be received by the locking assembly 36 as the pin 24 passes there through. One preferred embodiment of the locking assembly 30 comprises a ring 38 disposable in surrounding, concentric relation to the connector pin 24 when it is positioned within the interior of the channel 28 as clearly demonstrated in FIGS. 9B and 9C. In addition, the locking assembly 36 includes a plurality of spaced apart fingers 40 normally disposed in an outwardly angular orientation. As such outer portions of the plurality of fingers 40 movably engage the connector pin 24 when disposed within the channel 28. Further, the structure, configuration, disposition and outwardly angular orientation of each of the plurality of fingers 40 is such as to allow inward travel of the connector pin 20 as it passes into the interior of the attachment member 14 along the channel 28. However, the structure of the plurality of fingers 40 is such as to restrict movement of the connector member 24 in the opposite direction or out of the channel 28, such as when the separation of the attachment member 14 and the base 12 is attempted. The locking assembly 36 can therefore be further described as being disposed and structured to movably engage the connector pin 24 such that it facilitates movement or passage thereof inwardly into the interior of the attachment member 14 along the channel 28. In contrast, the structure and orientation of the plurality of fingers 40 is such as to restrict movement of the connector pin 24 in the opposite direction, out of the channel 28, such as when an attempt to disconnect the base 12 and the attachment member 14 from the intended operative position occurs.

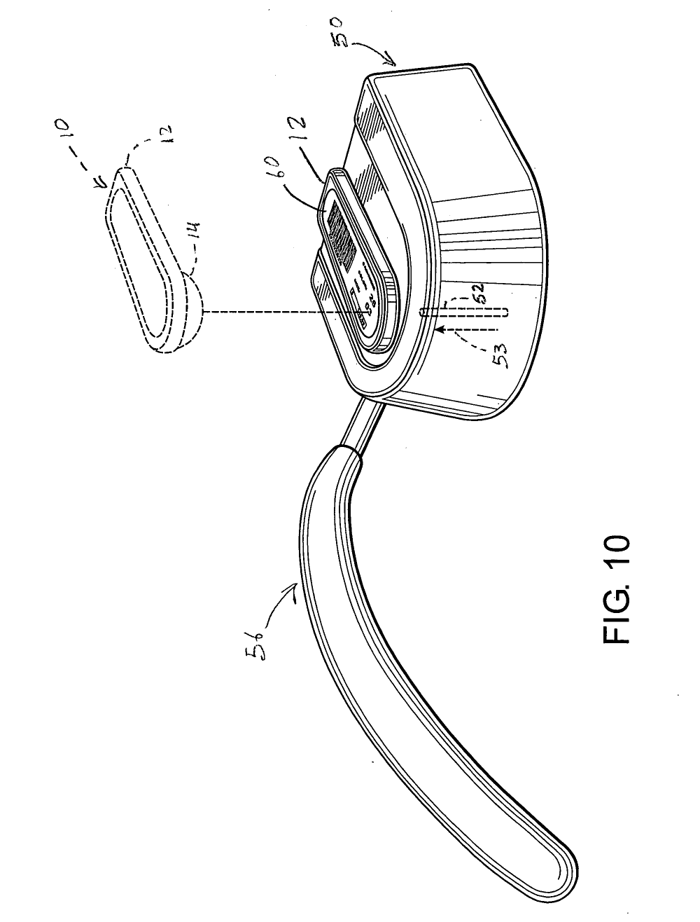

As set forth above, one operative feature of the various preferred embodiments of the present invention includes the ability to easily and quickly remove the security tag assembly 10 from the merchandise 18 utilizing authorized personnel, techniques and/or hardware. To the contrary, unauthorized separation of the base 12 and the associated attachment member 14 is rendered extremely difficult when the proper procedures and/or hardware are not utilized. With primary reference to FIGS. 9c, 9D and 10, separation of the base 12 and the attachment member 14 from their intended operative position in clamping engagement with the merchandise 18 can be easily accomplished utilizing approved or authorized detachment assembly generally indicated as 50. The detachment assembly 50 is intended to be representative only of a variety of different devices and/or hardware which could be applied to the security tag assembly 10 and structured to separate the base 12 from the attachment member 14 and detach the merchandise 18 therefrom without causing damage to the base 12 or merchandise 18. Therefore, the detachment assembly 50, as represented in FIG. 10 is not to be considered in a limiting sense since a variety of other structures can be utilized to accomplish separation of the various preferred embodiments of the security tag assembly 10 out of the operative position of FIG. 9B.

Accordingly, the detachment assembly 50 includes a cavity or like structure 51 (see FIGS. 9C and 9D) for receipt of an attachment member 14 therein when the tag assembly 10 is mounted on the detachment assembly 50 in the orientation disclosed in FIG. 10. In addition, the detachment assembly 50 comprises a drive shaft 52 and a holding or stabilizing structure 54. As also represented, an actuating handle or like structure generally indicated as 56 is connected by appropriate mechanical linkage to the drive shaft 52. A manipulation of the handle assembly 56 causes a positioning of the stabilizing structure 54 into engagement with corresponding portions of the attachment member 14 and a forced movement of the drive shaft 52 into the interior of the attachment member 14, in accordance with directional arrow 53.

The force of the drive shaft 52 will cause a rupture, displacement, detachment and/or otherwise destructive removal of a cover member or portion 47 which overlies and therefore covers or closes the distal end 32 of the channel 28. The specific structuring of the cover member 47 may vary such as being attached in its intended, overlying position to the channel 28 by a weakened or serrated connecting portion. Alternatively, the material from which the attachment member 14, as well as the cover portion 47 is formed may be such as to yield under the linearly directed force exerted thereon by the drive shaft 52 as it travels into the attachment member 14.

Continued travel of the drive shaft 52 into the interior of the channel 28, through the distal end 32, results in an engagement between the extremity 52′ of the drive shaft 52 and outer end portion 29 of the connector pin 24. As such, the continued travel and driving force of the drive shaft 52 will force the connector pin 24 out of the channel 28 and against the movement resisting engagement of the locking assembly 36 and the plurality of fingers 40. Also, disposition and structure of the locking assembly 36 including, but not limited to, the structure of the plurality of fingers 40 will cause a destruction, or at least partial deformation, of the locking assembly, as represented in FIG. 9D, as the connector pin 24 is forced outwardly from the channel 28 through the open end 30. Accordingly, the locking assembly 36 can be said to be “destructively detached” and/or displaced from a position relative to and engagement with the connector pin 24 as the pin 24 is forced outwardly from the channel 28 in the opposing direction to its direction of entry, as schematically indicated by directional arrow 55.

Once the base 12 and the attachment member 14 are separated from their intended operative position, connector pin 24 may also be easily removed from the merchandise 18. Therefore, the deformation or at least partial destruction of the locking assembly 36 will most probably render the associated attachment member 14 incapable of further use. The attachment member 14, once forcibly detached from the connector pin 24, such as in the manner described above, may be considered disposable. In contrast the base 12, as indicated above, can be repeatedly used by having others of a plurality of attachment members 14 independently connected thereto in the aforementioned and preferred operative position.

With primary reference to FIG. 7, yet another structural feature incorporated in at least one preferred embodiment of the present invention is the provision of a display field generally indicated as 60. The display field 60 is formed on any one of a plurality of different exterior surface portions of the base 12 such as on a rear or undersurface 62. The size and configuration of the display field 60 may vary and is at least partially dependent on the size, dimension and configuration of the base 12 as well as the intended informative data or information, generally indicated as 64, intended to appear thereon. The informative data 64 may include different information sections including a bar code, optical other electrically scanned indicia 66 and/or one or more plurality of printed data sections. The content of the predetermined information and/or data provided for viewing and external exposure would include merchandise information and/or other information regarding the origin, manufacture, distribution history, etc., associated with the merchandise 18 being protected. Other informative data may include physical characteristics of the merchandise or product 18 including size, color, material as well as the pricing thereof. The predetermined data or information, including such information identified as merchandise data is intended to be representative only of a variety of different information and/or data segments or portions which may appear in the display field 60.

Further, the predetermined data or information may be permanently, fixedly and/or removably secured within the display field 60 such as by a labeling and/or by an otherwise fixed and/or secured structuring extending over at least a portion of a corresponding surface 62. Also, the inclusion of the display field 60 can result in time and cost saving features, such as by connecting the security tag assembly 10 at the manufacturing site and thereby “identifying” the merchandise at this point in the product distribution system. By way of example, many products with which the security tag assembly 10 may be used are manufactured in locales having labor costs which are significantly lower than in the geographical location where the products are sold. Therefore, attachment of the security tag assembly 10, having the display field 60 and pertinent data 64 appearing thereon, at the manufacturing site, rather than at the retail outlet, could result in significant savings in labor costs, while assuring that the product is properly marked, described, identified, etc.

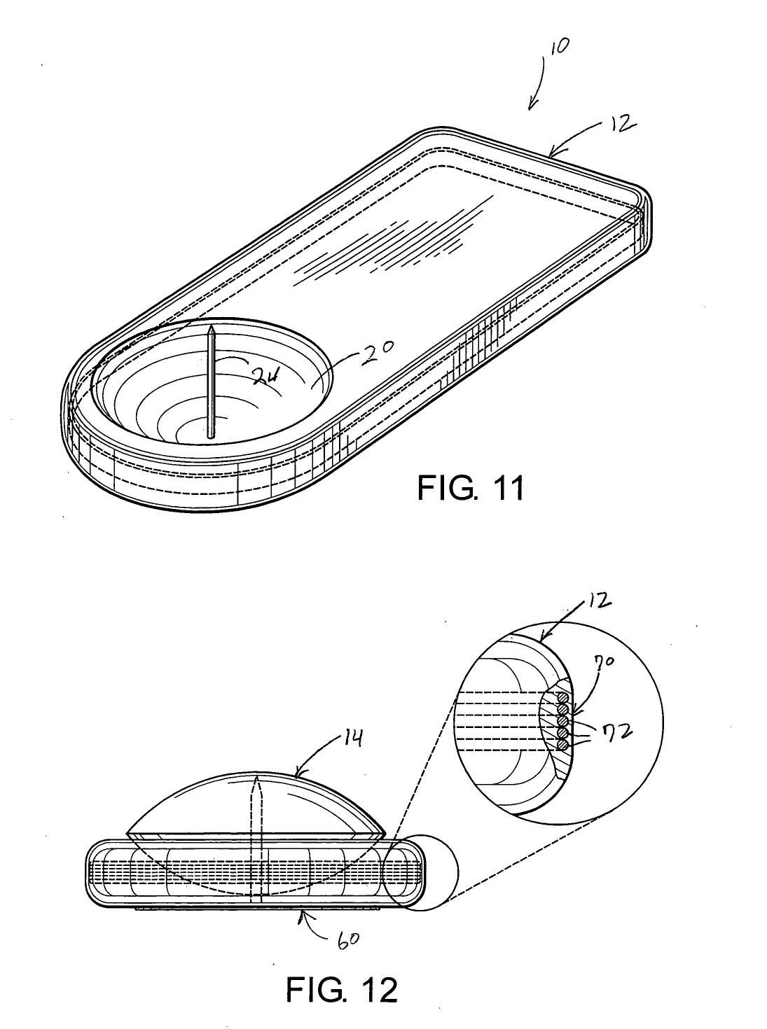

With primary reference to FIGS. 11 and 12, at least one preferred embodiment of the security tag assembly 10 of the present invention comprises an indicator assembly generally indicated as 70. The indicator assembly 70 is mounted and/or connected to the base 12 on at least a portion of the interior thereof as shown in detail in FIG. 12. In a most preferred embodiment of the indicator assembly 70 is formed from a plurality of conductive material coil segments or strands 72. The coil strands 72 may have an at least partially continuous configuration as they are collectively arranged and extend along at least a portion of the periphery of the base 12. As such, the indicator assembly 70 is capable of activating an alarm such as, but not limited to, a proximity alarm of the type typically found and/or associated with entrances and exits of retail establishments. In addition, the indicator assembly 70 comprising the multi-stand construction 72 is structured, configured and disposed to define a radio frequency (RF) coil capable of facilitating RF communication and/or signaling. As such, the RF coil may be modified to demonstrate “tracking” capabilities for the merchandise 18 to which it is attached.

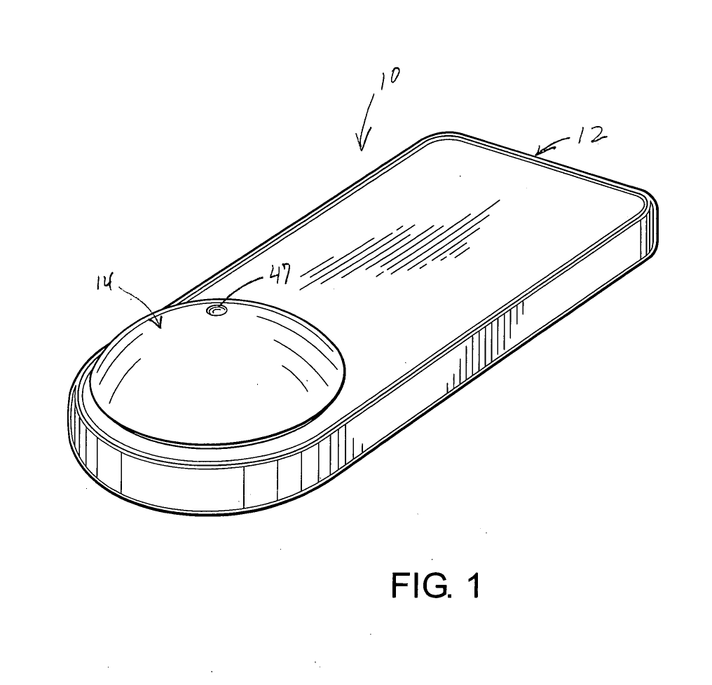

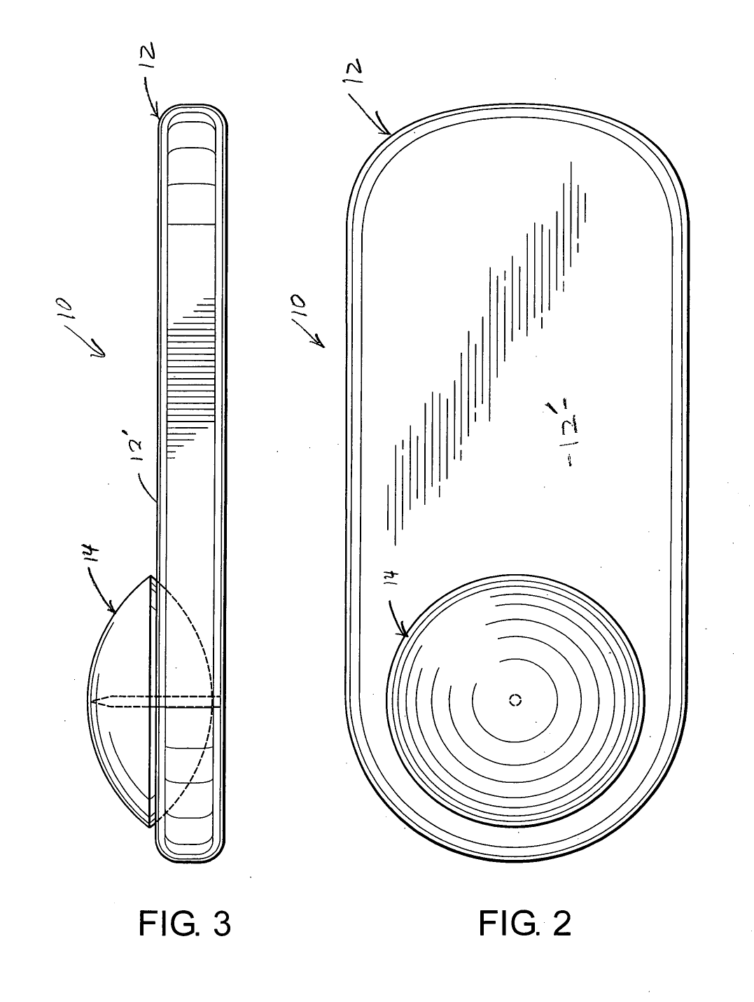

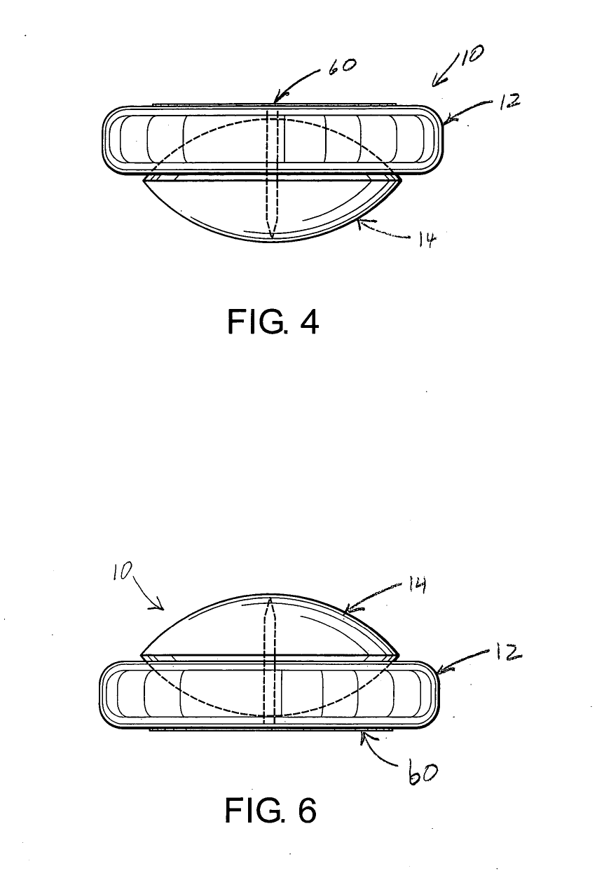

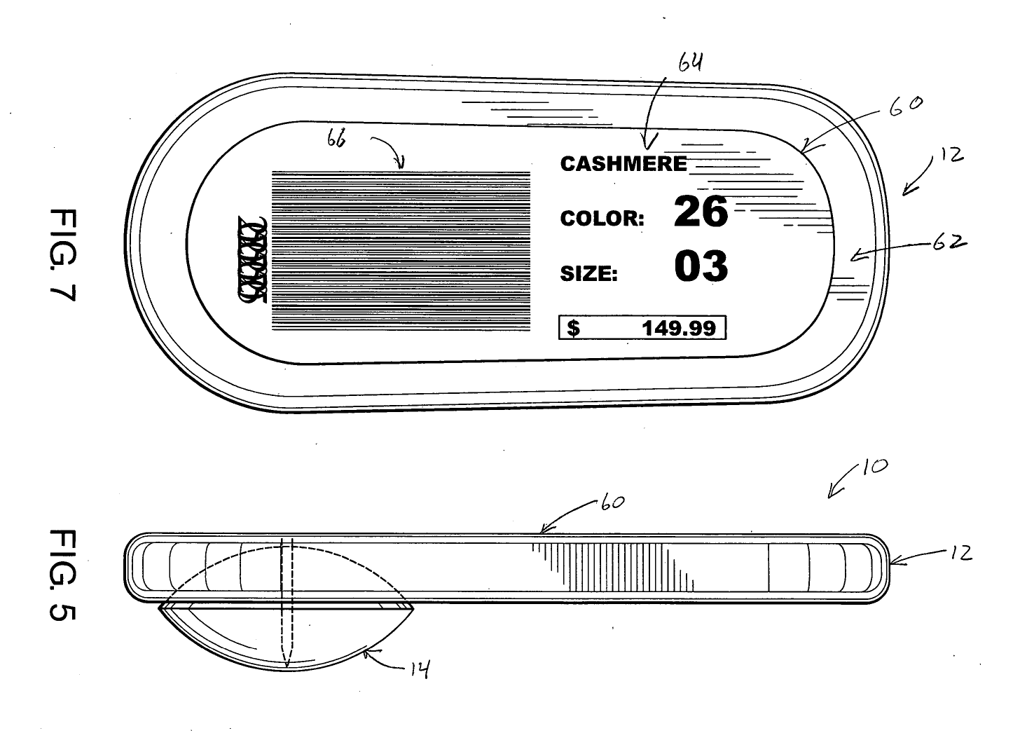

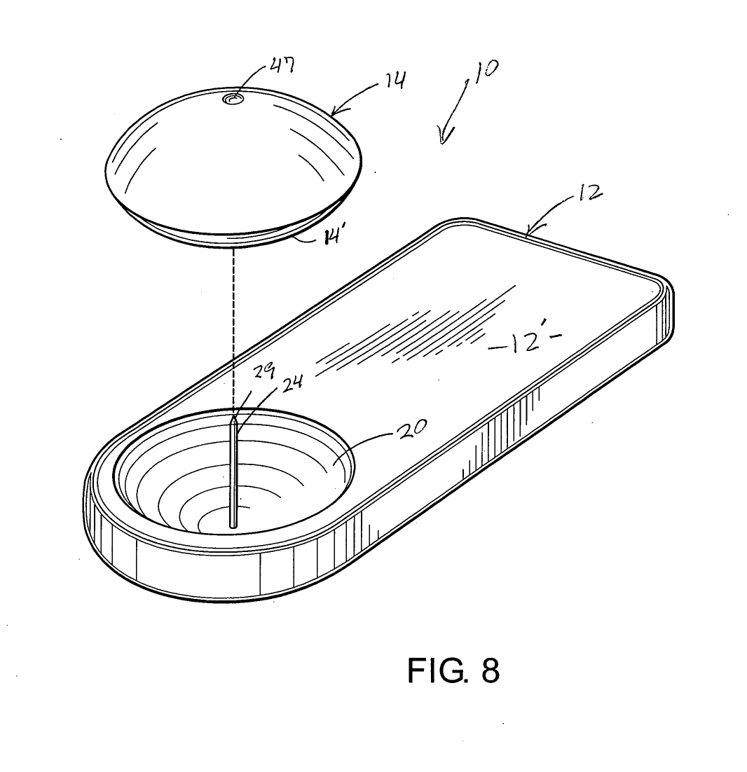

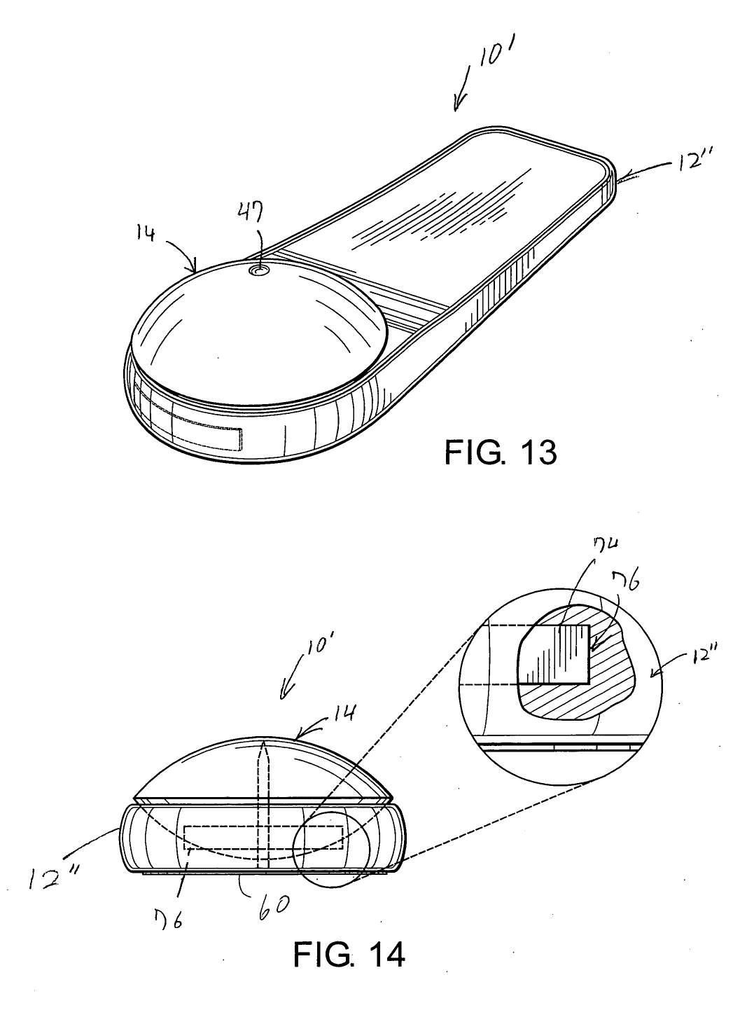

Yet another preferred embodiment of the present invention is represented in FIGS. 13 and 14. More specifically, the security tag assembly 10′ comprises a base 12″ and is structured, similar to the embodiments of FIGS. 1 through 12, to be connected to and used in combination with any one of a plurality of replaceable and disposable attachment members 14. Moreover, various components of the base 12″ and the one or more attachment members 14 are equivalently structured to operate in the same manner as described above with specific reference to FIGS. 1 through 12. However, the security tag assembly 10′ is distinguishable from the above-noted embodiments through the provision of a base 12″ having a varied or modified configuration from that of base 12. More specifically, the base 12″ may be somewhat thinner and/or tapered as clearly represented. This alteration in the overall configuration of the base 12″ may be at least partially due to the provision of an indicator assembly 74 mounted on and/or connected to the base 12″ preferably on the interior thereof in a somewhat hidden location. As such, the indicator assembly 74 includes a conductive or other appropriate material indicator member 76 which is specifically structured, disposed, configured, etc. relative to the structural features of the base 12″ to activate an alarm such as, but not limited to, a proximity type of alarm commonly associated with exits and entrances of retail establishments.

In comparing the different preferred embodiments of FIGS. 11, 12 and 13, 14 it is emphasized that the specific structural features in terms of dimensions and configurations may vary from those represented. However, the overall structure of the base 12 and/or 12″ should be readily adaptable to the mounting or connection thereto of an indicator assembly 70, 76 and/or a combination of both. Also, while the specific embodiments represented in FIGS. 11 through 14 of an indicator assembly 70 and 76 are specifically disclosed, other indicator assemblies may be provided which include the capability of activating an alarm of the type set forth above.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A security tag assembly structured to discourage unauthorized removal of merchandise from a given area, said security tag assembly comprising:
a) an attachment member and a base collectively disposable in an operative position relative to the merchandise;
b) a connector member secured to said base and structured to interconnect said attachment member and said base in said operative position;
c) a locking assembly mounted on said attachment member in engaging relation to said connector member; and
d) said operative position at least partially defined by the merchandise engaging said connector member and clamped between said attachment member and said base.

2. A security tag assembly as recited in claim 1 wherein said base comprises a display field disposed and structured to display predetermined merchandise data thereon.

3. A security tag assembly as recited in claim 2 wherein said display field comprises an exterior surface of said base.

4. A security tag assembly as recited in claim 1 wherein said base comprises a seat disposed and structured to receive said attachment member in said operative position.

5. A security tag assembly as recited in claim 4 wherein said seat comprises a recessed structure substantially corresponding to an exterior surface configuration of said attachment member.

6. A security tag assembly as recited in claim 5 wherein said connector member comprises an elongated pin secured to said recessed portion and extending outwardly from said seat into penetrating relation with said attachment member.

7. A security tag assembly as recited in claim 1 wherein said connector member comprises an elongated pin secured to and extending outwardly from said base, said pin disposed and dimensioned to pass into an interior of said attachment member into movement restricting engagement with said locking assembly when said base and said attachment member are in said operative position.

8. A security tag assembly as recited in claim 7 wherein said attachment member comprises an elongated channel disposed on an interior thereof, said channel dimensioned to receive said pin therein.

9. A security tag assembly as recited in claim 8 wherein said locking assembly is disposed within said interior of said attachment member in communicating relation with said channel and in receiving relation to said pin.

10. A security tag assembly as recited in claim 9 wherein said locking assembly is structured to restrict movement of said pin within said channel in one of two opposition directions.

11. A security tag assembly as recited in claim 1 wherein said locking assembly is disposed within an interior of said attachment member and in surrounding, movement restricting relation to said connector member when said attachment member and said base are in said operative position.

12. A security tag assembly as recited in claim 11 wherein said locking assembly is disposed and structured for unrestricted moving engagement with said connector member passing into said attachment member and restricted moving engagement with said connector member passing out of said attachment member.

13. A security tag assembly as recited in claim 12 wherein said locking member comprises a ring disposed in surrounding relation to said connector member and a plurality of locking fingers secured to said ring and extending angularly outward therefrom into movement restricting engagement with said connector member when said base and said attachment member are in said operative position.

14. A security tag assembly as recited in claim 1 further comprising an indicator assembly connected to said base and structured to activate at least one alarm associated with the given area.

15. A security tag assembly as recited in claim 14 wherein said indicator assembly comprises an RF coil structured to include tracking capabilities.

16. A security tag assembly structured to discourage unauthorized removal of merchandise from a given area, said security tag assembly comprising:
at least one attachment member and a base connectable to one another in an operative position;
a connector member secured to said base and extending outwardly therefrom into connected engagement with said attachment member;
a channel disposed within said attachment member and dimensioned to receive said connector member therein;
a locking assembly disposed in receiving relation to said connector member when disposed within said channel,
said locking member structured for unrestricted movement of said connector member passing into said channel and restricted movement of said connector member passing out of said channel, and
said operative position at least partially defined by the merchandise engaging said connector member and clamped between said attachment member and said base.

17. A security tag assembly as recited in claim 16 wherein said channel comprises a proximal end and a distal end each disposed substantially adjacent oppositely disposed exterior surfaces of said attachment member.

18. A security tag assembly as recited in claim 17 wherein said channel is disposed and dimensioned to extend along substantially an entire transverse dimension of said attachment member between said oppositely disposed exterior surfaces.

19. A security tag assembly as recited in claim 17 further comprising a cover connected to said attachment member in covering relation to said distal end.

20. A security tag assembly as recited in claim 19 wherein said proximal end is open and said cover is destructively removable from said distal end.

21. A security tag assembly as recited in claim 1 wherein said attachment member is removable from said base upon forced travel of said connector member out of said channel through said proximal end.

22. A security tag assembly as recited in claim 21 wherein said locking assembly is destructively detached out of movement restricting engagement with said connector member upon said forced travel of said connector member out of said channel.

23. A security tag assembly as recited in claim 1 wherein said base further comprises a display field disposed on an exterior thereof, said display field comprising predetermined data disposed thereon in an externally exposed position.

24. A security tag assembly as recited in claim 23 further comprising a plurality of said attachment members each independently connected to said base in said operative position.

25. A security tag assembly as recited in claim 24 wherein each of said plurality of attachment members are destructively removable from said base and are subsequently disposable.

26. A security tag assembly as recited in claim 1 further comprising an indicator assembly including at least one indicator member connected to said base and structured to facilitate RF communication with said base.

27. A security tag assembly as recited in claim 26 wherein said one indicator member comprises a conductive material coil.

28. A security tag assembly as recited in claim 27 wherein said coil comprises a substantially annular configuration mounted within said base and extending along a periphery thereof.

29. A security tag assembly structured to discourage unauthorized removal of merchandise from a given area, said security tag assembly comprising:
at least one base and a plurality of disposable attachment members each independently connected to said base in an operative position,
a connector member secured to said base and disposed and structured to engage the merchandise and concurrently interconnect any one of said plurality of attachment members to said base in said operative position,
each of said plurality of attachment members including a locking assembly disposed in movement restricting engagement with said connector member when in said operative position, at least some of said locking assemblies destructively detachable from said connector member upon separation of a corresponding attachment member from said base, and
a display field disposed on an exposed exterior of said base, said display field comprising predetermined informative data.

30. A security tag assembly as recited in claim 29 further comprising an indicator assembly including at least one indicator member connected to said base and structured to facilitate RF communication with said base.

31. A security tag assembly as recited in claim 30 wherein said one indicator member comprises a conductive material coil having a substantially annular configuration and mounted within said base and extending along a periphery thereof.
